(19) United States
(12) Patent Application Publication
(10) Pub. No.: US 2024/0050874 A1
(43) Pub. Date: Feb. 15, 2024

(54) FLUIDIC SEPARATORS AND ASSOCIATED METHODS

(71) Applicant: Zaiput Flow Technologies LLC, Waltham, MA (US)

(72) Inventors: Andrea Adamo, Cambridge, MA (US); Kevin Sheehan, Waltham, MA (US); Colin O'Shea, Somerville, MA (US)

(73) Assignee: Zaiput Flow Technologies LLC, Waltham, MA (US)

(21) Appl. No.: 18/271,331

(22) PCT Filed: Jan. 7, 2022
(86) PCT No.: PCT/US2022/011625

§ 371 Date: Jul. 7, 2023

Related U.S. Application Data
(60) Provisional application No. 63/136,072, filed on Jan. 11, 2021.

(51) Int. Cl. B01D 17/04; B01D 19/00; B01D 61/36; B01D 69/02

(52) U.S. Cl. CPC B01D 17/045; B01D 19/0031; B01D 61/366; B01D 69/02; B01D 2325/38; B01D 2325/36; B01D 2319/04; B01D 2319/06

(57) ABSTRACT

Devices and methods for separating multi-phase fluids, comprising a first porous medium portion and a second porous medium portion. The device comprises a fluidic channel comprising an inlet; the first porous medium portion between the fluidic channel and a first auxiliary outlet; and the second porous medium portion between the fluidic channel and a second auxiliary outlet. The method comprises presenting a combined flow comprising a first fluid phase and a second fluid phase to a separator, wherein the first porous medium portion has a higher affinity for the first fluid phase than for the second fluid phase, and the second porous medium portion has a higher affinity for the second fluid phase than for the first fluid phase.

### RELATED APPLICATIONS

This application claims priority under 35 U.S.C. § 119(e) to U.S. Provisional Patent Application No. 63/136,072, filed Jan. 11, 2021, and entitled “Fluidic Separators and Associated Methods,” which is incorporated herein by reference in its entirety for all purposes.

### TECHNICAL FIELD

Fluidic separators and associated methods are generally described.

### SUMMARY

The present disclosure is generally related to fluidic separators and associated methods. Certain aspects are directed to fluidic separators comprising a first porous medium portion and a second porous medium portion. The first and second porous medium portions can be used to separate components of a combined flow comprising two or more fluid phases. Methods of separating components within a combined flow comprising at least two fluid phases are also provided. The subject matter of the present disclosure involves, in some cases, interrelated products, alternative solutions to a particular problem, and/or a plurality of different uses of one or more systems and/or articles.

According to one aspect, a separator is disclosed. The separator comprises, according to certain embodiments, a fluidic channel comprising an inlet; a first porous medium portion defining at least a portion of a wall of the fluidic channel, the first porous medium portion between the fluidic channel and a first auxiliary outlet; and a second porous medium portion defining at least a portion of a wall of the fluidic channel, the second porous medium portion between the fluidic channel and a second auxiliary outlet.

In one aspect, a method is disclosed. In some embodiments, the method comprises presenting a combined flow comprising a first fluid phase and a second fluid phase to a separator comprising a first porous medium portion and a second porous medium portion, wherein: the first porous medium portion has a higher affinity for the first fluid phase than for the second fluid phase, such that the first fluid phase is preferentially transported through the first porous medium portion relative to the second fluid phase, and the second porous medium portion has a higher affinity for the second fluid phase than for the first fluid phase, such that the second fluid phase is preferentially transported through the second porous medium portion relative to the first fluid phase.

Other advantages and novel features of the present disclosure will become apparent from the following detailed description of various non-limiting embodiments when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand the disclosure.

FIG. 1A is, according to certain embodiments, a cross-sectional schematic illustration of a separator.

FIG. 1B is, according to certain embodiments, a cross-sectional schematic illustration showing the separation of two fluid phases using the separator shown in FIG. 1A.

FIG. 1C is, according to certain embodiments, a cross-sectional schematic illustration showing the separation of three fluid phases using the separator shown in FIG. 1A.

FIG. 1D is, according to certain embodiments, a first magnified cross-sectional schematic illustration of the separator of FIG. 1A.

FIG. 1E is, according to certain embodiments, a second magnified cross-sectional schematic illustration of the separator of FIG. 1A.

FIG. 1F is, according to certain embodiments, a cross-sectional schematic illustration of a separator.

FIG. 1G is, according to certain embodiments, a cross-sectional schematic illustration showing the separation of two fluid phases using the separator shown in FIG. 1F.

FIG. 1H is, according to certain embodiments, a cross-sectional schematic illustration of a separator.

FIG. 2A is, according to certain embodiments, a cross-sectional schematic illustration of a droplet on a surface having a relatively high affinity for the droplet, compared to the arrangement shown in FIG. 2B.

FIG. 2B is, according to certain embodiments, a cross-sectional schematic illustration of a droplet on a surface having a relatively low affinity for the droplet, compared to the arrangement shown in FIG. 2A.

FIG. 3 is, according to certain embodiments, a cross-sectional schematic illustration of a separator.

### DETAILED DESCRIPTION

The present disclosure is generally related to fluidic separators and associated methods. Certain aspects are directed to fluidic separators comprising a first porous medium portion and a second porous medium portion. The first and second porous medium portions can be used to separate components of a combined flow comprising two or more fluid phases. In certain cases, the first porous medium portion can have a higher affinity for the first fluid phase of the combined flow than for the second fluid phase of the combined flow, and the second porous medium portion can have a higher affinity for the second fluid phase of the combined flow than for the first fluid phase of the combined flow. It has been discovered that the use of multiple porous medium portions in this manner can, in accordance with certain embodiments, enhance the degree of separation of the first and second fluid phases and/or the efficiency with which the first and second fluid phases are separated. The use of multiple porous medium portions has also been found, within the context of the present disclosure, to enhance the degree of separation and/or the efficiency of separation for three phase mixtures.

In some embodiments, the first porous medium portion and the second porous medium portion can be placed at the same or a similar location along the flow direction of a fluidic channel. By arranging the first and second porous medium portions at the same or similar locations along the flow direction, the first porous medium portion can attract the first fluid phase away from the second porous medium portion, and the second porous medium portion can attract the second fluid phase away from the first porous medium portion. By reducing the degree to which the second fluid phase interacts with the first porous medium portion, one can enhance the degree to which the first porous medium portion is exposed to the first fluid phase, which can enhance the degree to which the first porous medium portion separates the first fluid phase from the combined flow. Similarly, by reducing the degree to which the first fluid phase interacts with the second porous medium portion, one can enhance the degree to which the second porous medium portion is exposed to the second fluid phase, which can enhance the degree to which the second porous medium portion separates the second fluid phase from the combined flow.

Certain aspects of the present disclosure are related to the recognition that, in the multiphase separation space, there are still unmet needs. In particular, in certain cases, there is a need to improve the separation of biphasic liquid-liquid emulsified systems and three-phase liquid-liquid-gas systems. Standard, gravity-based separation devices are typically large tanks that accommodate a horizontal flow of a multiphase mixture that needs to be separated. During flow, the heavy phase settles to the bottom and the light phase drifts to the top. Such devices are typically quite large because they require long settling time and therefore long residence time in the device.

In many previous separation systems, gravity has been used as the driving force. Under many circumstances, gravity-based separation techniques are either ineffective or highly inefficient. For instance, in a chemical synthesis process, phase separation can be used to isolate a phase or product of interest, or to carry out an extraction. In some such cases, the phases are emulsified. Under these conditions, the small droplet size of even a single phase can lead to a very long settling time. Settling time is proportional to density difference, meaning that when phases have similar density, separation might be impossible, inefficient, or extremely time-consuming.

Gravity-independent separation techniques can also cause problems in other systems. For example, in the fuel handling industry, high shear rate often present in gear pumps can lead to the breakup of water or air droplets that may be present in a fuel stream. This results in fine emulsions that are hard to separate and that typically have a substantial negative impact on engine/motor performance.

Furthermore, gravity-based phase separations are generally difficult to perform in outer space, where gravity is typically not available as a driving force for phase separation. It may be desirable, in many instances, to perform multi-phase separations in outer space (e.g., to allow for the development of manufacturing (e.g., polymers, drugs, fuel), testing, and purification (e.g., sampling, recycling) capabilities).

Accordingly, certain aspects of the disclosure are related to the recognition that gravity independent phase separation methods would be useful, and are sometimes necessary, for many applications.

Surface forces can be used to separate phases and perform gravity independent liquid-liquid separations (e.g., in a continuous flow chemistry system). For example, pressurized liquids can be transported to porous media, and separation may be achieved by taking advantage of the difference in wettability that the phases exhibit on a porous medium, by driving the wetting phase through pores of the porous medium while the nonwetting phase is left behind. In such systems, pressure must often be controlled to provide a driving force for the flow of the wetting phase through the porous medium without causing the flow of the nonwetting phase through the porous medium. Such methods often work poorly when flow rates lead to turbulent flow, however, because turbulence stirs the mixtures, interfering with the transport of droplets of the wetting phase to the porous medium portion and leading to retention. Such methods also often have suboptimal performance when applied to highly emulsified systems. In such systems, a dispersed phase can typically only be separated when it contacts a porous medium with appropriate wetting properties. However, a continuous phase of the emulsion might prevent the dispersed phase from ever reaching the porous medium.

Thus, better separators and separation processes are needed. Certain aspects of the disclosure are related to separators and separation processes that exhibit improved efficiency, reduced costs, and/or reduced size, among other potential advantages.

The fluidic separators disclosed herein are generally configured such that, during operation, the fluidic separator takes in a combined flow of two or more phases (e.g., a suspension of two or more components, an emulsion of two or more components, mixed solvents, slugs of one liquid in another, and/or bubbles of a gas in a liquid), produces a first product stream that is enriched in one of the phases relative to the combined flow inlet, and produces a second product stream that is enriched in another of the phases relative to the combined flow inlet. Additional detail regarding the properties and operation of exemplary fluidic separators is provided below.

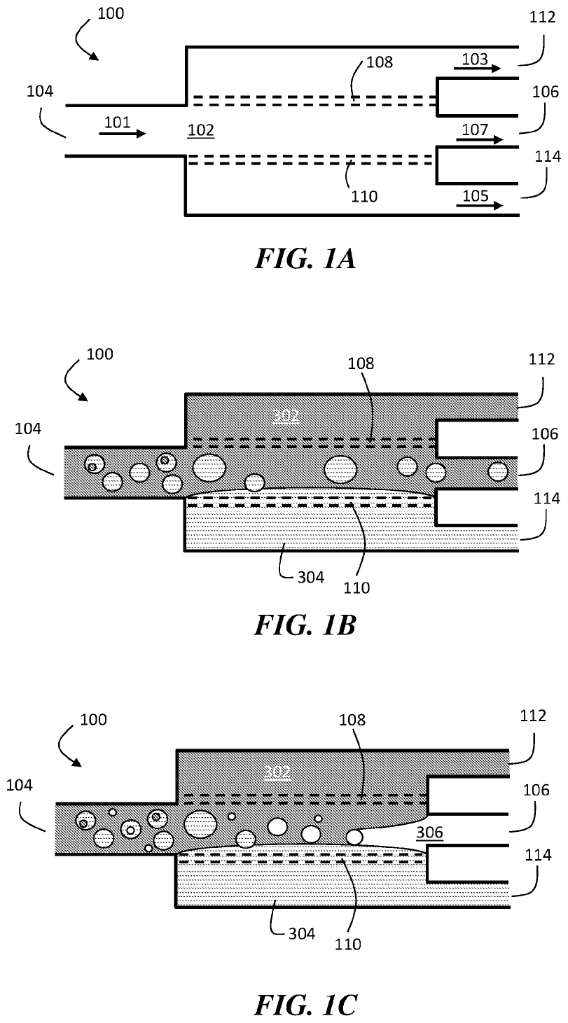

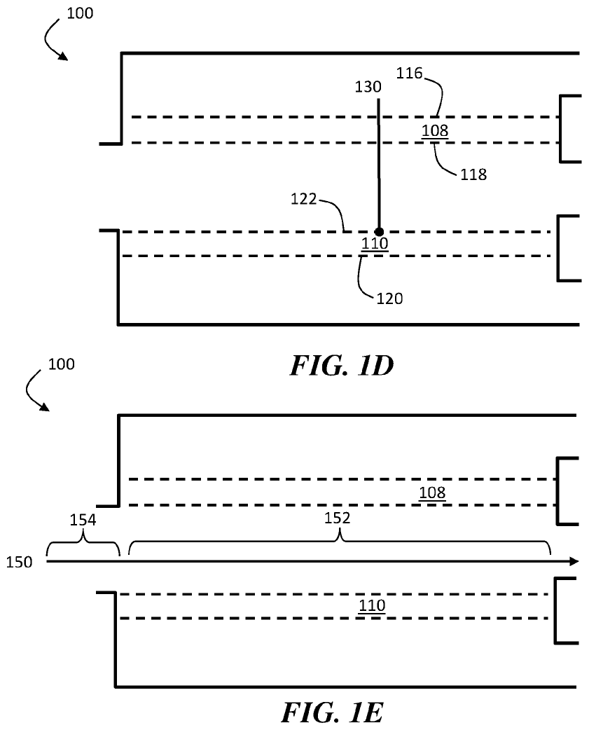

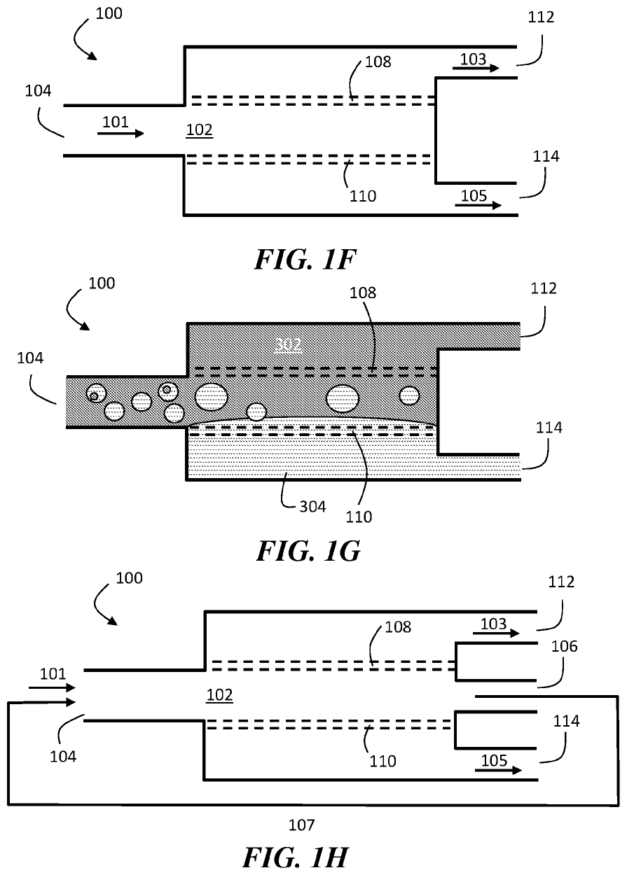

Certain aspects are directed to separators. FIG. 1A is a cross-sectional schematic illustration of separator 100, in accordance with certain embodiments. In some embodiments, the separator comprises a fluidic channel. For example, referring to FIG. 1A, separator 100 comprises fluidic channel 102. The fluidic channel comprises, in certain embodiments, an inlet. For example, in FIG. 1A, fluidic channel 102 comprises inlet 104. In some embodiments, the fluidic channel comprises an outlet. For example, in FIG. 1A, fluidic channel 102 comprises outlet 106. In other embodiments, the fluidic channel does not comprise an outlet. For example, in FIG. 1F, fluidic channel 102 does not comprise an outlet. In some embodiments, and as explained in more detail below, a combined flow can be presented to the separator via inlet 104. In addition, outlet 106 can allow for one or more phases to exit the fluidic channel, to avoid pressure buildup within the fluidic channel.

The separator may also comprise, in accordance with certain embodiments, porous medium portions. A porous medium portion may be used, in some embodiments, to separate a component of the combined flow from one or more other components of the combined flow. The use of multiple porous medium portions, optionally arranged in certain advantageous ways, can allow for enhanced separation of the phases presented to the separator in the combined flow inlet. Additional details regarding such separations are provided below.

In some embodiments, the separator comprises a first porous medium portion. In FIG. 1A, for example, separator 100 comprises first porous medium portion 108. In some embodiments, the first porous medium portion is or is part of a porous membrane. The first porous medium portion can, according to some embodiments, define at least a first portion of a wall of the fluidic channel. In FIG. 1A, for example, first porous medium portion 108 defines a first portion of the top wall of fluidic channel 102. As described in more detail below, the first porous medium portion can be configured such that a first fluid phase of the combined flow presented to the fluidic channel is preferentially transported through the porous medium portion, resulting in the formation of a stream that is enriched in the first fluid phase relative to the combined flow inlet. In some embodiments, the first porous medium portion is between the fluidic channel and a first auxiliary outlet. “Auxiliary outlet,” in the context of the present disclosure, is used to distinguish the outlet of the fluidic channel (if present) from other outlets of the separator. In FIG. 1A, first porous medium portion 108 is disposed between fluidic channel 102 and first auxiliary outlet 112. In some embodiments, the stream enriched in the first fluid phase relative to the combined flow inlet can exit the separator via the first auxiliary outlet.

The separator may also comprise, in some embodiments, a second porous medium portion. In FIG. 1A, for example, separator 100 comprises second porous medium portion 110. In some embodiments the second porous medium portion is or is part of a porous membrane. In some embodiments the second porous medium portion defines at least a portion of a wall of the fluidic channel. In FIG. 1A, for example, second porous medium portion 110 defines a portion of the bottom wall of fluidic channel 102. As described in more detail below, the second porous medium portion can be configured such that a second fluid phase of the combined flow presented to the fluidic channel is preferentially transported through the second porous medium portion, resulting in the formation of a stream that is enriched in the second fluid phase relative to the combined flow presented to the separator. In some embodiments, the second porous medium portion is between the fluidic channel and a second auxiliary outlet. In FIG. 1A, for example, second porous medium portion 110 is disposed between fluidic channel 102 and second auxiliary outlet 114. In some embodiments, the stream enriched in the second fluid phase relative to the combined flow inlet can exit the separator via the second auxiliary outlet.

Certain aspects are directed to methods of separating fluids. The separation methods disclosed herein generally comprise the presentation of a combined flow to the fluidic channel. A “combined flow” refers to a flow of multiple phases of fluids. The combined flows described herein can be any of a variety of combinations of fluid phases. The combined flow may include, for example, a suspension of two or more components, an emulsion of two or more components, slugs of one liquid in another, and/or bubbles of a gas in a liquid or combination of liquids.

Those of ordinary skill in the art are familiar with a variety of combinations of multiple fluid phases. Each fluid phase within the combined flow does not necessarily have to be in the form of a different state of matter. For example, a mixture of two liquids can form a two-phase combined flow, as long as each of the two liquids can be discerned from the other within the combined flow. In some embodiments, the multi-phase mixture comprises a first liquid and a second liquid, and the two liquids can have limited solubility in each other, leading to the formation of an interface between the two liquids. In some embodiments, the solubility of the first liquid in the second liquid is less than or equal to 10 mg/mL, less than or equal to 1 mg/mL, or less than or equal to 0.1 mg/mL at 20° C. In certain embodiments, the combined flow can further comprise a third fluid phase (e.g., a gas phase) with limited solubility in the other two fluid phases. For example, in some embodiments, the solubility of the third fluid phase in each of the first fluid phase (e.g., a first liquid phase) and the second fluid phase (e.g., a second liquid phase) is less than or equal to 10 mg/mL, less than or equal to 1 mg/mL, or less than or equal to 0.1 mg/mL at 20° C.

Exemplary types of combined flow include: a gas phase dispersed as bubbles within a liquid phase; a laminated liquid phase and gas phase; two laminated liquid phases, optionally with a gas phase that is separated from and/or distributed throughout the liquid phases; and an emulsion of one liquid in another, optionally with a gas phase that is separated from and/or distributed throughout the liquid phases. Any of these types of combined flow may be presented to a separator, but these types are nonlimiting and other types of combined flow are contemplated.

In some instances, a combined flow may comprise an oil-in-water type emulsion, wherein an aqueous fluid phase is dispersed throughout a continuous, organic fluid phase. In certain instances, a combined flow may comprise a water-in-oil type emulsion, wherein an organic fluid phase is dispersed throughout a continuous, aqueous fluid phase. Nested emulsions can also be used. For example, a nested emulsion in which the first fluid phase is dispersed within droplets of the second fluid phase, which are dispersed within an additional fluid phase (e.g., more of the first fluid phase, or within a third fluid phase) could be used as the combined flow. The type of emulsion used can depend upon a number of parameters such as the relative quantities of the first fluid phase and the second fluid phase (and, if present, third or additional fluid phases), as well as the mode of agitation. In some embodiments, the separator and methods of separation disclosed herein may achieve a high degree of separation, even when the combined flow comprises a nested emulsion, because the combined flow becomes progressively separated as it travels down the fluidic channel.

In some embodiments, a method of separation comprises presenting a combined flow comprising a first fluid phase and a second fluid phase to the separator, such that some of the combined flow is directed toward an outlet of the fluidic channel. For example, in FIG. 1B, a combined flow comprising first fluid phase 302 (shown in gray) and second fluid phase 304 (shown in horizontal hatching) has been transported through inlet 104 of fluidic channel 102, and some of the combined flow is directed towards outlet 106 of the fluidic channel. In some embodiments, the first fluid phase is a liquid phase, and the second fluid phase is a liquid phase.

In some embodiments, a method of separation comprises presenting a combined flow comprising a first fluid phase and a second fluid phase to the separator, such that none of the combined flow is directed toward an outlet of the fluidic channel. For example, in FIG. 1G, a combined flow comprising first fluid phase 302 (shown in gray) and second fluid phase 304 (shown in horizontal hatching) has been transported through inlet 104 of fluidic channel 102, where fluidic channel 102 has no outlet.

Some embodiments comprise transporting a portion of the combined flow out of the separator. In some embodiments, at least a portion of the combined flow that is transported out of the separator may be recycled back into the separator. In some embodiments, a fluid stream recycled from the portion of the combined flow out of the separator may be directed towards the inlet of the fluidic channel to rejoin the combined flow. For example, in FIG. 1H, after exiting outlet 106 of fluidic channel 102, fluid stream 107 is directed to inlet 104 of fluidic channel 102, where it merges with combined flow 101 before it is directed to separator 100. In some embodiments, one or more of the fluid phases comprising product stream 107 is a liquid phase.

In some embodiments the combined flow further comprises a third fluid phase. For example, in FIG. 1C, a combined flow comprising first fluid phase 302 (shown in gray), second fluid phase 304 (shown in horizontal hatching), and a third fluid phase (shown in white) has been transported through inlet 104 of fluidic channel 102. In some embodiments, the third fluid phase is a gas phase. For example, in some embodiments, the combined flow comprises a first liquid phase, a second liquid phase (e.g., a second liquid that is immiscible with the first liquid), and a gas phase. In some embodiments, the third fluid phase may be a liquid phase. For example, in some embodiments, the combined flow comprises a first liquid phase, a second liquid phase (e.g., a second liquid that is immiscible with the first liquid), and a third liquid phase (e.g., a third liquid that is immiscible with the first liquid and the second liquid).

In certain embodiments, the third fluid phase may be a part of the initial combined flow. In certain embodiments, the third fluid phase may be added to the combined flow deliberately. In certain embodiments, the first and second fluid phase are incompressible, while the third fluid phase has an associated pressure. In some embodiments, the third fluid phase may be used to control a pressure of the combined flow. In some embodiments, the pressure of the combined flow may be chosen to maintain a target pressure differential across porous medium portions.

In certain embodiments, each of the first and second porous medium portions may have an affinity for one of the fluid phases that is higher than its affinity for the other fluid phase(s) in the combined flow. The “affinity” of a porous medium portion with respect to a particular fluid refers to the degree to which the fluid wets the porous medium portion. Relative affinities of two liquids for a particular porous medium portion can be determined, for example, by analyzing the contact angle between the porous medium portion and the liquids. The “contact angle” of a particular fluid phase is measured through the bulk of the fluid phase. If a contact angle between a first fluid phase and the porous medium portion is smaller than a contact angle between a second fluid phase and the porous medium portion, then the porous medium portion would be said to have a higher affinity for the first fluid phase than the second fluid phase.

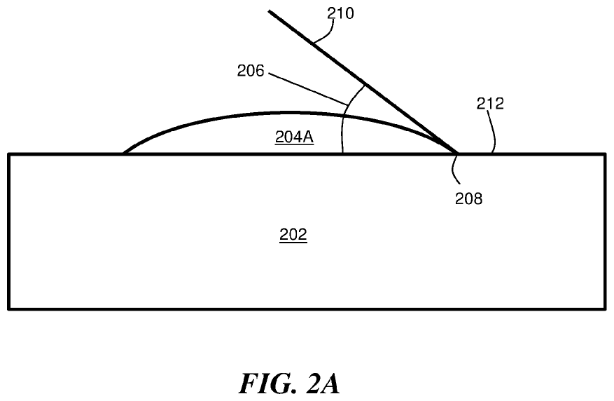

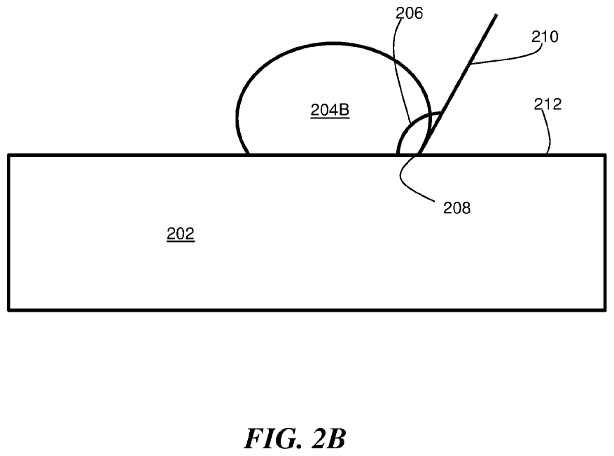

To illustrate, FIG. 2A shows an exemplary cross-sectional schematic diagram illustrating the interaction of liquid droplet 204A of a first fluid phase with surface 212 of porous medium portion 202. Contact angle 206 is measured through the bulk of droplet 204A. As shown in FIG. 2A, contact angle 206 is measured between (1) line 210 drawn tangent to the exterior surface of droplet 204A at point of contact 208 with surface 212 and (2) surface 212. In FIG. 2A, contact angle 206 is about 50°. Because this angle is less than 90°, surface 212 is considered to be wetting with respect to droplet 204A of the liquid. In contrast, FIG. 2B is an exemplary cross-sectional schematic diagram illustrating the interaction of a liquid droplet 204B of a second fluid phase with a surface when the surface is non-wetting with respect to the liquid. Contact angle 206 between droplet 204B of the liquid on surface 212 is about 120° in FIG. 2B. Because this angle is greater than or equal to 90°, surface 212 is considered to be non-wetting with respect to droplet 204B of the liquid. Also, because the contact angle established between droplet 204A and surface 212 is smaller than the contact angle established between droplet 204B and surface 212, porous medium portion 202 is said to have a higher affinity for the droplet 204A of the first fluid phase (in FIG. 2A) than for the droplet 204B of the second fluid phase (in FIG. 2B).

In some embodiments, for one, both, or all of the porous medium portions in the separator, the contact angle between a surface of the porous medium portion and at least one of the fluid phases of the combined flow (e.g., the fluid phase of the combined flow for which the surface has the highest affinity) may be relatively small. For example, according to certain embodiments, this contact angle may be less than or equal to 85°, less than or equal to 75°, less than or equal to 65°, less than or equal to 55°, less than or equal to 45°, less than or equal to 35°, less than or equal to 25°, less than or equal to 15°, less than or equal to 5°, or less. In some embodiments, for one, both, or all of the porous medium portions in the separator, the contact angle between a surface of the porous medium portion and at least one of the fluid phases of the combined flow (e.g., the fluid phase of the combined flow for which the surface has the highest affinity) may be greater than or equal to 1°, greater than or equal to 2°, greater than or equal to 5°, greater than or equal to 10°, greater than or equal to 15°, greater than or equal to 25°, greater than or equal to 35°, greater than or equal to 45°, or more. Combinations of these values are also possible (e.g., greater than or equal to 1° and less than or equal to 5°, or greater than or equal to 5° and less than or equal to 65°).

In some embodiments, for one, both, or all of the porous medium portions in the separator, the contact angle between a surface of the porous medium portion and at least one of the fluid phases of the combined flow (e.g., the fluid phase of the combined flow for which the surface has the lowest affinity) may be relatively large. For example, according to certain embodiments, this contact angle may be greater than or equal to 100°, greater than or equal to 105°, greater than or equal to 110°, greater than or equal to 120°, greater than or equal to 130°, greater than or equal to 140°, greater than or equal to 150°, greater than or equal to 160°, greater than or equal to 170°, or more. In some embodiments, for one, both, or all of the porous medium portions in the separator, the contact angle between a surface of the porous medium portion and at least one of the fluid phases of the combined flow (e.g., the fluid phase of the combined flow for which the surface has the lowest affinity) may be less than or equal to 179°, less than or equal to 170°, less than or equal to 160°, less than or equal to 150°, less than or equal to 140°, less than or equal to 130°, less than or equal to 120°, or less. Combinations of these values are also possible (e.g., greater than or equal to 100° and less than or equal to 179°, or greater than or equal to 150° and less than or equal to 170°).

In some embodiments, the first porous medium portion has a higher affinity for the first fluid phase than for the second fluid phase. For example, in FIGS. 1B-1C, first porous medium portion 108 has a higher affinity for first fluid phase 302 than for second fluid phase 304. In accordance with certain embodiments, the first porous medium portion's affinity for the first fluid phase may be higher than its affinity for the second fluid phase such that the contact angle between the first porous medium portion and the first fluid phase is at least 2° (or at least 5°, at least 15°, at least 25°, at least 50°, at least 70°, at least 90°, at least 115°, at least 145°, or at least 160°) smaller than the contact angle between the first porous medium portion and the second fluid phase.

In some embodiments the first porous medium portion's higher affinity for the first fluid phase than for the second fluid phase causes the first fluid phase to be preferentially transported through the first porous medium portion relative to the second fluid phase. The preferential transport of the first fluid phase through the first porous medium portion can lead to the formation of a stream that is enriched in the first fluid phase relative to the combined flow inlet. For example, in FIGS. 1B-1C, first fluid phase 302 has been preferentially transported through first porous medium portion 108 to form stream 103 that is enriched in first fluid phase 302 relative to combined flow 101. In some embodiments, the volumetric flux of the first fluid phase through the first porous medium portion (i.e., the volume of first fluid phase transported through the first porous medium portion per unit of facial area of the first porous medium portion) is at least 1.5, at least 2, at least 5, at least 10, at least 50, at least 100, or at least 1000 times greater than the volumetric flux of the second fluid phase through the first porous medium portion. In some embodiments, the volumetric flux of the first fluid phase through the first porous medium portion is at least 1.5, at least 2, at least 5, at least 10, at least 50, at least 100, or at least 1000 times greater than the volumetric flux of all other fluid phases through the first porous medium portion.

In some embodiments, the selective transport of the first fluid phase through the first porous medium portion results in the production of a relatively pure stream of the first fluid phase. For example, in some embodiments, at least 50 wt %, at least 75 wt %, at least 85 wt %, at least 90 wt %, at least 95 wt %, at least 99 wt %, at least 99.9 wt %, or at least 99.99 wt % of the second fluid phase that was present in the combined flow presented to the separator can be removed from the product stream that is enriched in the first fluid phase. Referring to FIG. 1A, for example, in accordance with some embodiments, at least 50 wt % (or at least 75 wt %, at least 85 wt %, at least 90 wt %, at least 95 wt %, at least 99 wt %, at least 99.9 wt %, or at least 99.99 wt %) of the second fluid phase in combined flow 101 fed to the separator has been removed from product stream 103. In some embodiments, at least 50 wt %, at least 75 wt %, at least 85 wt %, at least 90 wt %, at least 95 wt %, at least 99 wt %, at least 99.9 wt %, or at least 99.99 wt % of all fluid phases present in the combined flow that are not the first fluid phase can be removed from the product stream that is enriched in the first fluid phase (e.g., product stream 103 in FIGS. 1A-1C). To determine the amount of a particular phase that has been “removed from” a product stream, one would divide the difference between the mass percentage of that particular phase in the combined flow and the mass percentage of that particular phase in the product stream by the mass percentage of that particular phase in the combined flow and multiple by 100%. Expressed mathematically, the percentage of a particular phase “removed from” a product stream would be:

$${Removal}_{\%} = ( \frac{{W}_{C F} - {W}_{P S}}{{W}_{C F}} ) \times 100 \%$$

Where Removal_{%} is the percentage of a particular phase removed from a product stream, W_{CF} is the weight percentage of the particular phase within the combined flow, and W_{PS} is the weight percentage of the particular phase within the product stream. In FIG. 1B, for example, 100% of second fluid phase 304 has been removed from product stream 103.

In certain embodiments, the first product stream (e.g., stream 103) contains the first fluid phase in an amount of at least 90 wt %, at least 95 wt %, at least 99 wt %, at least 99.9 wt %, at least 99.99 wt %, at least 99.999 wt %, or more.

In some embodiments, the second porous medium portion has a higher affinity for the second fluid phase than for the first fluid phase. For example, in FIGS. 1B-1C, second porous medium portion 110 has a higher affinity for second fluid phase 304 than for first fluid phase 302. In accordance with certain embodiments, the second porous medium portion's affinity for the second fluid phase may be higher than its affinity for the first fluid phase such that the contact angle between the second porous medium portion and the second fluid phase is at least 2° (or at least 5°, at least 15°, at least 25°, at least 50°, at least 70°, at least 90°, at least 115°, at least 145°, or at least 160°) smaller than the contact angle between the second porous medium portion and the first fluid phase.

In certain embodiments, the porous media and the fluid phases can form the contact angles (or relative contact angles) mentioned herein when measured at 25° C., 1 atm of pressure, and in air.

In some embodiments the second porous medium portion's higher affinity for the second fluid phase than for the first fluid phase causes the second fluid phase to be preferentially transported through the second porous medium portion relative to the first fluid phase. The preferential transport of the second fluid phase through the second porous medium portion can lead to the formation of a stream that is enriched in the second fluid phase relative to the combined flow inlet. For example, in FIGS. 1B-1C, second fluid phase 304 has been preferentially transported through second porous medium portion 110 to form stream 105 that is enriched in second fluid phase 304 relative to combined flow 101. In some embodiments, the volumetric flux of the second fluid phase through the second porous medium portion is at least 1.5, at least 2, at least 5, at least 10, at least 50, at least 100, or at least 1000 times greater than the volumetric flux of the first fluid phase through the second porous medium portion. In some embodiments, the volumetric flux of the second fluid phase through the second porous medium portion is at least 1.5, at least 2, at least 5, at least 10, at least 50, at least 100, or at least 1000 times greater than the volumetric flux of all other fluid phases through the second porous medium portion.

In some embodiments, the selective transport of the second fluid phase through the second porous medium portion can result in the production of a relatively pure stream of the second fluid phase. For example, in some embodiments, at least 50 wt %, at least 75 wt %, at least 85 wt %, at least 90 wt %, at least 95 wt %, at least 99 wt %, at least 99.9 wt %, or at least 99.99 wt % of the first fluid phase that was present in the combined flow fed to the separator can be removed from the product stream that is enriched in the second fluid phase. Referring to FIG. 1A, for example, in some embodiments, at least 50 wt % (or at least 75 wt %, at least 85 wt %, at least 90 wt %, at least 95 wt %, at least 99 wt %, at least 99.9 wt %, or at least 99.99 wt %) of the first fluid phase in combined flow 101 fed to the separator has been removed from product stream 105. In some embodiments, at least 50 wt %, at least 75 wt %, at least 85 wt %, at least 90 wt %, at least 95 wt %, at least 99 wt %, at least 99.9 wt %, or at least 99.99 wt % of all phases present in the combined flow that are not the second fluid phase can be removed from the product stream that is enriched in the second fluid phase (e.g., product stream 105 in FIGS. 1A-1C).

In certain embodiments, the second product stream (e.g., stream 105) contains the second fluid phase in an amount of at least 90 wt %, at least 95 wt %, at least 99 wt %, at least 99.9 wt %, at least 99.99 wt %, at least 99.999 wt %, or more.

The separators used herein can be used to separate any of a variety of combined flows. In some embodiments, the first fluid phase of the combined flow is an aqueous liquid phase (e.g. water) and the second fluid phase is a non-aqueous liquid phase (e.g. oil). In other embodiments, the first fluid phase is a first non-aqueous liquid phase (e.g., a non-aqueous liquid having a first polarity) and the second fluid phase is a second non-aqueous liquid phase (e.g., a non-aqueous liquid having a second polarity that is different from the polarity of the first non-aqueous liquid). The desired relative affinities of the first and second fluid phases for the first and second porous medium portions can be achieved by selecting appropriate combinations of porous medium portion materials for the mixture. For example, if the first fluid phase is aqueous, and the second fluid phase is organic, one could select a first porous medium portion that is hydrophilic (which would attract the aqueous first fluid phase) and a second porous medium portion that is hydrophobic (which would attract the organic phase). As another example, if the first and second fluid phases are both organic, one could select a first porous medium portion that is hydrophilic (which would attract the less polar of the two organic phases) and a second porous medium portion that is hydrophobic (which would attract the more polar of the two organic phases). Alternatively, if the first and second fluidic phases are both organic, one could select a first porous medium portion that is hydrophobic to a relatively small degree (which would attract the less polar of the two organic phases) and a second porous medium portion that is hydrophobic to a relatively large degree (which would attract the more polar of the two organic phases).

As used herein, a material is said to be “hydrophobic” when a droplet of water positioned on the material in air at 25° C. and at atmospheric pressure forms a contact angle of at least 90° on the material. A material is said to be “hydrophilic” when a droplet of water positioned on the material in air at 25° C. and at atmospheric pressure forms a contact angle of less than 90° on the material.

Accordingly, in some embodiments, the first porous medium portion of the separator is hydrophilic, and the second porous medium portion of the separator is hydrophobic. In some embodiments, the first porous medium portion and the second porous medium portion are both hydrophilic, with the first porous medium portion being more hydrophilic than the second porous medium portion. In some embodiments, the first porous medium portion and the second porous medium portion are both hydrophobic, with the first porous medium portion being more hydrophobic than the second porous medium portion. The third fluid phase, when present, can be, for example, a gas phase (e.g. atmospheric air, inert gases such as argon or nitrogen, or any other gas). The third fluid phase, when present, can also be a liquid phase (e.g., fluorinated oil)

In some embodiments, the first porous medium portion and the second porous medium portion can overlap each other at at least one location along the flow direction of the fluidic channel. “Overlap,” in this context, indicates that, at a location in the flow direction of the fluidic channel, both the first porous medium portion and the second porous medium portion are present. One example of this arrangement is shown in FIG. 1E, where first porous medium portion 108 overlaps second porous medium portion 110 at all locations along flow direction 150 that are within region 152. (In contrast, first porous medium portion 108 does not overlap second porous medium portion 110 at the locations along flow direction 150 that are within region 154.)

By arranging the first and second porous medium portions such that they at least partially overlap in this manner, the first porous medium portion can attract the first fluid phase away from the second porous medium portion, and the second porous medium portion can attract the second fluid phase away from the first porous medium portion. By reducing the degree to which the second fluid phase interacts with the first porous medium portion, one can enhance the degree to which the first porous medium portion is exposed to the first fluid phase, which can enhance the degree to which the first porous medium portion separates the first fluid phase from the combined flow. Similarly, by reducing the degree to which the first fluid phase interacts with the second porous medium portion, one can enhance the degree to which the second porous medium portion is exposed to the second fluid phase, which can enhance the degree to which the second porous medium portion separates the second fluid phase from the combined flow.

In some embodiments, the preferential transport of the first fluid phase through the first porous medium portion results in the concentration and coalescence of the second fluid phase within one or more regions of the fluidic channel. This can increase the likelihood that those portions of the second fluid phase will reach the second porous medium portion and be preferentially transported into the second fluid phase product stream. Similarly, in some embodiments, the preferential transport of the second fluid phase through the second porous medium portion results in the concentration and coalescence of the first fluid portion within one or more regions of the fluidic channel, increasing the likelihood that those portions of the first fluid phase will reach the first porous medium portion (and be preferentially transported into the first fluid phase product stream). For example, in FIG. 1B, the preferential transport of first fluid phase 302 through first porous medium portion 108 results in the concentration and coalescence of the droplets of second fluid phase 304 within fluidic channel 102, which increases the likelihood that those droplets of the second fluid phase will reach second porous medium portion 110 and be preferentially transported into second fluid phase product stream 105. In addition, in FIG. 1B, the preferential transport of second fluid phase 304 through second porous medium portion 110 results in the concentration of first fluid phase 302 in regions above those droplets in fluidic channel 102, which increases the likelihood that the first fluid phase within those regions will reach first porous medium portion 108 and be preferentially transported into first fluid phase product stream 103. This interaction between the first fluid phase, the second fluid phase, the first porous medium portion, and the second porous medium portion can increase the degree to which the fluid phases are separated and reduce the amount of time needed to perform the separation. This interaction can also reduce “retention” within the separator (described in more detail below).

As noted above, in certain embodiments, a third fluid phase may be present in the combined flow that is introduced to the separator.

In some embodiments, the first porous medium portion has a higher affinity for the first fluid phase than for the third fluid phase. For example, in FIG. 1C, first porous medium portion 108 has a higher affinity for first fluid phase 302 than for third fluid phase 306. In some embodiments, the first porous medium portion's higher affinity for the first fluid phase than for the third fluid phase causes the first fluid phase to be preferentially transported through the first porous medium portion relative to the third fluid phase. For example, in FIG. 1C, first fluid phase 302 has been preferentially transported through first porous medium portion 108, relative to third fluid phase 306, to form stream 103 that is enriched in first fluid phase 302 relative to combined flow 101. In some embodiments, the volumetric flux of the first fluid phase through the first porous medium portion is at least 1.5, at least 2, at least 5, at least 10, at least 50, at least 100, or at least 1000 times greater than the volumetric flux of the third fluid phase through the first porous medium portion.

In some embodiments, the selective transport of the first fluid phase through the first porous medium portion results in the production of a stream of the first fluid phase that has little of the third fluid phase. For example, in some embodiments, at least 50 wt %, at least 75 wt %, at least 85 wt %, at least 90 wt %, at least 95 wt %, at least 99 wt %, at least 99.9 wt %, or at least 99.99 wt % of the third fluid phase that was present in the combined flow fed to the separator can be removed from the product stream that is enriched in the first fluid phase. Referring to FIG. 1A, for example, in some embodiments, at least 50 wt % (or at least 75 wt %, at least 85 wt %, at least 90 wt %, at least 95 wt %, at least 99 wt %, at least 99.9 wt %, or at least 99.99 wt %) of the third fluid phase in combined flow 101 fed to the separator has been removed from product stream 103.

In some embodiments, the second porous medium portion has a higher affinity for the second fluid phase than for the third fluid phase. For example, in FIG. 1C, second porous medium portion 110 has a higher affinity for second fluid phase 304 than for third fluid phase 306. In some embodiments, the second porous medium portion's higher affinity for the second fluid phase than for the third fluid phase causes the second fluid phase to be preferentially transported through the second porous medium portion relative to the third fluid phase. For example, in FIG. 1C, second fluid phase 304 has been preferentially transported through second porous medium portion 110, relative to third fluid phase 306, to form stream 105 that is enriched in second fluid phase 304 relative to combined flow 101. In some embodiments, the volumetric flux of the second fluid phase through the second porous medium portion is at least 1.5, at least 2, at least 5, at least 10, at least 50, at least 100, or at least 1000 times greater than the volumetric flux of the third fluid phase through the second porous medium portion.

In some embodiments, the selective transport of the second fluid phase through the second porous medium portion results in the production of a stream of the second fluid phase that has little of the third fluid phase. For example, in some embodiments, at least 50 wt %, at least 75 wt %, at least 85 wt %, at least 90 wt %, at least 95 wt %, at least 99 wt %, at least 99.9 wt %, or at least 99.99 wt % of the third fluid phase that was present in the combined flow fed to the separator can be removed from the product stream that is enriched in the second fluid phase. Referring to FIG. 1A, for example, in some embodiments, at least 50 wt % (or at least 75 wt %, at least 85 wt %, at least 90 wt %, at least 95 wt %, at least 99 wt %, at least 99.9 wt %, or at least 99.99 wt %) of the third fluid phase in combined flow 101 fed to the separator has been removed from product stream 105.

In some embodiments, the third fluid phase can flow out of the separator via the outlet of the fluidic channel. For example, referring to FIGS. 1A-1C, in some embodiments, a third fluid phase can flow out of separator 100 via outlet 106 of fluidic channel 102. In some embodiments, at least 50 wt %, at least 75 wt %, at least 85 wt %, at least 90 wt %, at least 95 wt %, at least 99 wt %, at least 99.9 wt %, or at least 99.99 wt % of the third fluid phase that is present in the fluidic combination fed to the separator will remain in the fluidic channel and be transported through the outlet of the fluidic channel.

In some embodiments, the flow out of the outlet of the fluidic channel is enriched in the third fluid phase relative to the combined flow that enters the fluidic channel. For example, For example, referring to FIG. 1A, in some embodiments, at least 50 wt % (or at least 75 wt %, at least 85 wt %, at least 90 wt %, at least 95 wt %, at least 99 wt %, at least 99.9 wt %, or at least 99.99 wt %) of the third fluid phase in combined flow 101 fed to separator 100 will be transported out of outlet 106 of fluidic channel 102 via stream 107. In certain embodiments, at least 50 wt % (or at least 75 wt %, at least 85 wt %, at least 90 wt %, at least 95 wt %, at least 99 wt %, at least 99.9 wt %, or at least 99.99 wt %) of the first fluid phase in combined flow 101 fed to the separator has been removed from product stream 107. In certain embodiments, at least 50 wt % (or at least 75 wt %, at least 85 wt %, at least 90 wt %, at least 95 wt %, at least 99 wt %, at least 99.9 wt %, or at least 99.99 wt %) of the second fluid phase in combined flow 101 fed to the separator has been removed from product stream 107.

In certain embodiments, the third product stream (e.g., stream 107) contains the third fluid phase in an amount of at least 90 wt %, at least 95 wt %, at least 99 wt %, at least 99.9 wt %, at least 99.99 wt %, at least 99.999 wt %, or more.

Any of a variety of porous media can be used as the first porous medium portion and/or the second porous medium portion.

In some embodiments, the first porous medium portion may be relatively large. In some embodiments, the surface area of a facial surface of the first porous medium portion is at least 1 cm², at least 10 cm², at least 100 cm², at least 1000 cm², at least 1 m², or greater. In some embodiments, at least 1 cm², at least 10 cm², at least 100 cm², at least 1000 cm², at least 1 m², or more of a facial surface of the first porous medium portion faces the second porous medium portion.

In some embodiments, the second porous medium portion may be relatively large. In some embodiments, the surface area of a facial surface of the second porous medium portion is at least 1 cm², at least 10 cm², at least 100 cm², at least 1000 cm², at least 1 m², or greater. In some embodiments, at least 1 cm², at least 10 cm², at least 100 cm², at least 1000 cm², at least 1 m², or more of a facial surface of the second porous medium portion faces the first porous medium portion.

Generally, the porous medium portion comprises a solid material having fluid passageways bridging its thickness such that fluid may be transported from a first side of the porous medium portion, through the thickness of the porous medium portion, and to the opposite side of the porous medium portion. In some instances, the fluid passageways may be openings, such as tortuous pores, an array of microfabricated channels in a solid structure, and the like. In some instances, the porous medium portion may comprise a solid matrix comprising an array of microfabricated channels forming a plurality of substantially straight passageways. In certain embodiments, the porous medium portion may comprise a material which can function as a selective barrier between two or more fluids, such as a membrane.

The porous medium portion may be made of any of a variety of suitable materials. Examples of materials from which the solid portion of the porous medium portion may be made include, but are not limited to, metals, semiconductors, ceramics, polymers, and combinations thereof. In some embodiments, the solid portion of the porous medium portion comprises polyvinylidene fluoride (PVDF), polytetrafluoroethylene (PTFE), cellulose acetate, regenerated cellulose, polypropylene, polyethylene, polysulfane, polyether sulfone, nylon, polyester, polycarbonate, polyvinyl chloride, aluminum oxide, zirconium oxide, borosilicate glass fiber, aluminum, silver, and/or stainless steel. However, these choices of materials are non-limiting, and other choices of material are contemplated.

In some embodiments, the porous medium portion may be modified (e.g., coated, functionalized, etc.) with one or more materials. Functionalization of the surface portion may be performed, for example, to impart desirable surface properties (e.g., hydrophobicity, hydrophilicity, etc.). In some embodiments, the porous medium portion has been subjected to chemical modification of the surface to change its wetting and/or affinity properties. For example, in some embodiments, a porous medium portion may have been subjected to chemical modification to become more hydrophilic. In some embodiments, a porous medium portion may have been subjected to chemical modification to become more hydrophobic.

Although, in some embodiments, porous medium portions comprise only one layer, in other embodiments porous medium portions may comprise multiple layers. In some embodiments, a first layer of a porous medium portion may have an affinity for one or more fluid phases of the combined flow. In some embodiments, a second layer is positioned to cover at least a portion of the first layer. In some embodiments, the second layer is substantially permeable to one or more fluid phases of the combined flow. In some embodiments, the second layer provides mechanical support to the first layer.

The first porous medium portion and the second porous medium portion can correspond to two different portions of the same porous medium, or they can correspond to portions of two separate porous media. For example, in FIG. 1A, first porous medium portion 108 is illustrated as a first porous medium, and second porous medium portion 110 is illustrated as a second porous medium separate from the first porous medium. The disclosure is not so limited, however. As one non-limiting example, one portion of a hydrophobic porous membrane could be modified (e.g., coated with a surface coating) to make that portion of the porous membrane more hydrophilic. In such embodiments, the unmodified portion of the porous membrane could serve as the first porous medium portion and the modified portion of the porous membrane could serve as the second porous medium portion. The porous medium could then be folded such that the first porous medium portion faces the second porous medium portion.

In some embodiments, at least a portion of the first porous medium portion faces the second porous medium portion. For example, in certain cases, at least a portion of a facial surface of the first porous medium portion faces the second porous medium portion. As used herein, the facial surfaces of a porous medium portion refer to the external surfaces of the porous medium portion through which fluid is transported during separation. For example, referring to FIG. 1D (which shows a magnified view of the separator 100 shown in FIGS. 1A-1B), first porous medium portion 108 comprises two facial surfaces: 116 and 118. In addition, in FIG. 1D, second porous medium portion 110 comprises two facial surfaces: 120 and 122.

As used herein, a surface or surface portion (e.g., a portion of a facial surface) is said to be “facing” an object when a line extending perpendicular to and away from that surface or surface portion intersects the object. For example, a portion of a facial surface of a first porous medium portion would be facing a second porous medium portion if a line perpendicular to that portion of the facial surface of the first porous medium portion and extending away from the bulk of the material of the first porous medium portion intersects the second porous medium portion. To illustrate, in FIG. 1D, a portion of facial surface 122 of second porous medium portion 110 faces first porous medium portion 108 because line 130 extending perpendicular to and away from a portion of facial surface 122 of second porous medium portion 110 intersects first porous medium portion 108.

A surface can be facing another object when it is in contact with the other object, or when one or more intermediate materials are positioned between the surface and the other object. For example, two surfaces that are facing each other can be in contact or can include one or more intermediate materials between them.

The facial surfaces of the porous medium portions can be flat or curved. As shown in FIG. 1B, for example, facial surfaces 118 and 122 are flat. In other embodiments (e.g., in embodiments in which the first and second porous medium portions are arranged in a roll), the facial surfaces of the porous medium portions can be curved. (In instances in which a surface is curved, the line that is perpendicular to a particular point on that curved surface is a line that is perpendicular to a plane that is tangent to that particular point on the curved surface.)

In some embodiments, the first and second porous medium portions can be arranged such that there is a relatively high degree of overlap between the porous medium portions. For example, in some embodiments, at least 25%, at least 50%, at least 75%, at least 90%, at least 95%, at least 99%, or more of an area of a facial surface of the first porous medium portion faces the second porous medium portion. In FIG. 1B, for example, substantially 100% of the area of facial surface 118 of first porous medium portion 108 faces second porous medium portion 110. In some embodiments, at least 25%, at least 50%, at least 75%, at least 90%, at least 95%, at least 99%, or more of the area of a facial surface of the second porous medium portion faces the first porous medium portion.

In some instances, at least a portion (e.g., at least 25%, at least 50%, at least 75%, at least 90%, at least 95%, at least 99%, or more) of a facial surface of the first porous medium portion can be substantially parallel to and/or substantially concentric with at least a portion (e.g., at least 25%, at least 50%, at least 75%, at least 90%, at least 95%, at least 99%, or more) of a facial surface of the second porous medium portion.

Two surface portions (e.g. portions of a facial surface of the first porous medium, the second porous medium) are substantially parallel if the maximum angle defined between the two surface portions is less than or equal to 10°. In some embodiments, the maximum angle defined between two substantially parallel surface portions is less than or equal to 5°, less than or equal to 2°, or less than or equal to 1°. One example of substantially parallel surface portions is shown in FIG. 1B, in which 100% of the area of facial surface 118 of first porous medium portion 108 is perfectly parallel to 100% of the area of facial surface 122 of second porous medium portion 110.

Two surface portions are substantially concentric with each other if the larger of the two radii of curvature is within 10% of the smaller of the two radii of curvature. In some embodiments, for two surface portions that are substantially concentric with each other, the larger of the two radii of curvature is within 5%, within 2%, or within 1% of the smaller of the two radii of curvature.

In some embodiments, the first porous medium portion and/or the second porous medium portion may be arranged as a sheet. In some embodiments, the sheet has a thickness dimension and at least one lateral dimension (perpendicular to the thickness dimension) that is at least 10 times, at least 100 times, at least 1000 times, at least 10,000 times, or at least 10⁶ times greater than the thickness of the sheet. In some embodiments, the sheet has a thickness dimension and two lateral dimensions (each lateral dimension perpendicular to the other lateral dimension and to the thickness of the sheet) that is at least 10 times, at least 100 times, at least 1000 times, at least 10,000 times, or at least 10⁶ times greater than the thickness of the sheet. In some embodiments, the thickness of the first porous medium portion and/or the second porous medium portion is at least 100 nm, at least 1 micrometer, at least 10 micrometers, or at least 1 millimeter. In some embodiments, the thickness of the first porous medium portion and/or the second porous medium portion is less than or equal to 10 millimeters. Combinations of these ranges (e.g., at least 100 nm and less than or equal to 10 millimeters) are also possible. In some embodiments, the porous medium can be a thin and/or flexible material coupled to a permeable support layer (which can be made of different material than the porous medium portion itself).

In certain embodiments, at least one of the porous medium portions (e.g., the first porous medium portion and/or the second porous medium portion) comprises pores having a diameter of at least 10 nanometers, at least 100 nanometers, or more. In some embodiments, at least one of the porous medium portions (e.g., the first porous medium portion and/or the second porous medium portion) comprises pores having a diameter of less than or equal to 100 micrometers, less than or equal to 10 micrometers, less than or equal to 1 micrometer, or less. Combinations of these ranges are also possible (e.g., at least 10 nanometers and less than or equal to 10 micrometers).

In some embodiments, at least 10% (or at least 25%, at least 50%, at least 75%, at least 90%, at least 95%, or at least 99%, or more) of the pore volume of at least one of the porous medium portions (e.g., the first porous medium portion and/or the second porous medium portion) is made up of pores having a diameter of at least 10 nanometers, at least 100 nanometers, or more. In some embodiments, at least 10% (or at least 25%, at least 50%, at least 75%, at least 90%, at least 95%, or at least 99%, or more) of the pore volume of at least one of the porous medium portions (e.g., the first porous medium portion and/or the second porous medium portion) is made up of pores having a diameter of less than or equal to 100 micrometers, less than or equal to 10 micrometers, less than or equal to 1 micrometer, or less. Combinations of these ranges are also possible (e.g., at least 10 nanometers and less than or equal to 10 micrometers).

In certain embodiments, at least one of the porous medium portions (e.g., the first porous medium portion and/or the second porous medium portion) is an ultrafiltration membrane. In certain embodiments, at least one of the porous medium portions (e.g., the first porous medium portion and/or the second porous medium portion) is a microfiltration membrane.

The pore size of a particular pore and the pore size distribution of a particular porous medium portion can be determined using mercury intrusion porosimetry.

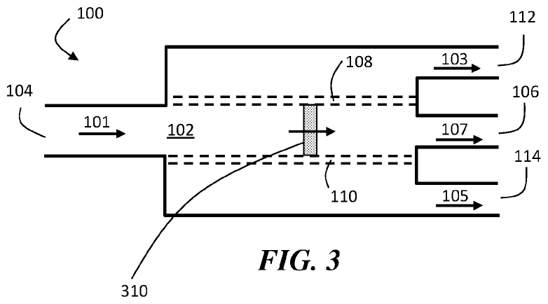

In some embodiments, one or more solid materials (also referred to herein as “spacers”) can be positioned between the first porous medium portion and the second porous medium portion. The spacer(s) can be used to maintain physical separation between the facial areas of the first and second porous medium portions, which can allow for the flow of a combined fluid between the facial areas of the first and second porous medium portions. For example, FIG. 3 is a cross-sectional schematic illustration of an embodiment of separator 100, where porous medium portion 108 is separated from porous medium portion 110, by spacer 310. In some embodiments, the spacer can be permeable to at least one (or all) fluids within the combined flow. The spacers can be integrated into one or both of the porous medium portions, or they may be configured such that they are separable from the first and second porous medium portions. In some embodiments, the spacer(s) can be configured such that the average spacing between the first and second porous medium portions across at least a portion (e.g., at least 10%, at least 25%, at least 50%, at least 75%, at least 95%, at least 99%, or more) of the facial area of the first porous medium portion and/or across at least a portion (e.g., at least 10%, at least 25%, at least 50%, at least 75%, at least 95%, at least 99%, or more) of the facial area of the second porous medium portion is at least at least 0.5 mm, at least 1 mm, at least 2 mm, or greater. In some embodiments, the spacer(s) can be configured such that the average spacing between the first and second porous medium portions across at least a portion (e.g., at least 10%, at least 25%, at least 50%, at least 75%, at least 95%, at least 99%, or more) of a facial area of the first porous medium portion and/or across at least a portion (e.g., at least 10%, at least 25%, at least 50%, at least 75%, at least 95%, at least 99%, or more) of a facial area of the second porous medium portion is less than or equal to 10 mm, less than or equal to 8 mm, less than or equal to 5 mm, or less.

In some embodiments, the distance between the first porous medium portion and the second porous medium portion may be chosen to control the quality of separation. For instance, narrowing the fluidic channel of an exemplary separator would, in some cases, increase the velocity of a fluid flow within that channel, which can, in some instances, provide sufficient drag to prevent droplets of the first fluid phase or the second fluid phase from flowing through the porous medium portion portions, even if they have contacted a wetting surface. In some cases, widening the fluidic channel of an exemplary separator could increase the average distance between droplets of the first fluid phase and the first porous medium portion, or between the second fluid phase and the second porous medium portion. In some embodiments, the preferred geometry for the fluidic channel may depend on a composition of the combined flow, choice of porous medium portion, and/or the pressure of the fluidic cavity.

In some embodiments, the first and/or second porous medium portions can be pre-wetted with the first and/or second fluid phases, respectively. Pre-wetting can, in certain cases, enhance the degree and efficiency with which the separations described herein are achieved. In general, the porous medium portion has a capillary pressure associated with the fluid passageways in the porous medium portion and the components of the combined flow to which the porous medium portion is exposed. The capillary pressure (P_{cap}) can be quantified as follows:

$${P}_{cap} = \frac{2 γcos ( θ )}{r} \qquad [ 1 ]$$

where θ is the contact angle formed between the solid material of the porous medium portion, the first fluid that is to be separated, and the second fluid to be separated; r is the radius of the pore; and gamma (γ) is the interfacial tension with respect to the first fluid to be separated and the second fluid to be separated. In some embodiments, the capillary pressure is the maximum differential pressure for substantially complete separation of a fluid mixture, such that substantially complete separation of a fluid mixture cannot occur at or above the capillary pressure but can occur below the capillary pressure. In some embodiments, the pressure inside the fluidic channel is controlled so that differential pressure across each of the first porous medium portion and the second porous medium portion does not exceed that porous medium portion's capillary pressure. In some embodiments, the pressure inside the fluidic channel is controlled so that the pressure differential across both porous medium portions does not exceed the minimum of the capillary pressures of the first porous medium portion and the second porous medium portion.

In some embodiments, the porous medium portion is configured to enhance the separation of fluids. In certain embodiments, the porous medium portion is pre-wetted with one liquid from the combined flow. In some such embodiments, the liquid type that has been used to pre-wet the porous medium portion is selectively passed through the pre-wetted porous medium portion. As would be understood by those of ordinary skill in the art, “selective” transport of a first component through a porous medium portion (the “selectively transported component”) relative to another component (the “selectively retained component”) means that a higher percentage of the selectively transported component is transported through the porous medium portion, resulting in the formation of a fluid on the permeate side of the porous medium portion that is enriched in the selectively transported component (relative to the combined flow being transported into the separator) and a fluid on the retentate side of the porous medium portion that is enriched in the selectively retained component (again, relative to the combined flow being transported into the separator). For example, in FIG. 1A, porous medium portion 108 can be pre-wetted with the material of the first fluid phase of the combined flow, such that the material of the first fluid phase is selectively transported through the porous medium portion (e.g., with application of a hydraulic pressure to the retentate side of the porous medium portion) while material of the second fluid phase is selectively retained by the porous medium portion.

In some instances, the pores within the porous medium portion within a separator are sized such that, when the porous medium portion is pre-wetted with one of the fluids within the incoming combined flow and the pressure of the incoming stream is sufficiently high, the pre-wetted fluid type is selectively transported through the porous medium portion while the other fluid(s) within the incoming combined flow are selectively retained by the porous medium portion. Specific pore properties may be selected, in certain cases, to enhance the selectivity of the porous medium portion for a particular fluid.

In some embodiments, separators are configured to reduce the occurrence of failure modes. Two exemplary failure modes are breakthrough and retention. Breakthrough failure occurs because one of the fluid phases traverses a porous medium portion which has a stronger affinity for another fluid phase. In an exemplary occurrence, breakthrough failure occurs when the pressure differential across the porous medium portion exceeds the capillary pressure, causing the meniscus at a pore to break, so that the wetting phase cannot be kept separated from the nonwetting phase. Retention failures occur when a fluid phase does not fully traverse the porous member within the separator which has the highest affinity for it, and instead is collected from the outlet of the fluidic channel. In an exemplary occurrence, retention failure occurs if the pressure differential that should drive the flow of the liquid through the porous medium portion is insufficient, causing the liquid to be left in the fluidic channel. In another exemplary occurrence, retention failure occurs if droplets of a fluid never have an opportunity to interact with the porous medium portion with the highest affinity for them, and hence cannot be separated out. In exemplary separators breakthrough and retention failures can be reduced through adequate sizing of the porous medium portion. Sizing of the porous medium portion may comprise choosing the pore size of the porous media, and/or choosing the facial area of the porous medium portion exposed to the combined flow. Alternatively, in exemplary separators, breakthrough and retention failures can be reduced by adjusting the pressure differential across the porous medium portions.

In some instances, a flux (e.g. a mass flux or a volume flux) of the first fluid phase is less than is desirable (e.g., substantially smaller than a flux of the second fluid phase). This can, in some cases, mean that the first fluid phase has difficulty wetting the first porous medium portion. In some embodiments, the size of the first porous medium portion may be selected to mitigate this effect and improve separation. In some embodiments, the first porous medium portion may be pre-wetted to mitigate this effect and improve separation.

In some instances, an analogous effect occurs when a flux (e.g. a mass flux or a volume flux) of the second fluid phase is smaller than is desirable (e.g., substantially smaller than a flux of the first fluid phase). This can, in some cases, mean that the second fluid phase has difficulty wetting the second porous medium portion. In some embodiments, the size of the second porous medium portion may be selected to mitigate this effect and improve separation. In some embodiments, the second porous medium portion may be pre-wetted to mitigate this effect and improve separation.

In accordance with some embodiments, the separator is configured to separate an incoming combined flow at a volumetric flow rate greater than or equal to 0.01 mL/min, greater than or equal to 1 mL/min, greater than or equal to 10 mL/min, greater than or equal to 100 mL/min, greater than or equal to 1 L/min, greater than or equal to 10 L/min, or greater than or equal to 100 L/min. For example, in some embodiments, separator 100 in FIG. 1A is configured to separate an input fed to separator 100 at a volumetric flow rate greater than or equal to 0.01 mL/min, greater than or equal to 1 mL/min, greater than or equal to 10 mL/min, greater than or equal to 100 mL/min, greater than or equal to 1 L/min, greater than or equal to 10 L/min, or greater than or equal to 100 L/min. In certain embodiments, the fluidic system is configured to separate an input at a volumetric flow rate less than or equal to 10,000 L/min, less than or equal to 1,000 L/min, less than or equal to 500 L/min, less than or equal to 100 L/min, less than or equal to 10 L/min, less than or equal to 3 L/min, less than or equal to 1 L/min, less than or equal to 500 mL/min, or less than or equal to 100 mL/min. For example, in some embodiments, separator 100 in FIG. 1A is configured to separate an input fed to separator 100 at a volumetric flow rate less than or equal to 10,000 L/min, less than or equal to 1,000 L/min, less than or equal to 500 L/min, less than or equal to 100 L/min, less than or equal to 10 L/min, less than or equal to 3 L/min, less than or equal to 1 L/min, less than or equal to 500 mL/min, or less than or equal to 100 mL/min. Combinations of these ranges are also possible. For example, in some instances, the fluidic system is configured to separate an input at a volumetric flow rate between 0.01 mL/min and 10,000 L/min (inclusive) or at a volumetric flow rate between 1 mL/min and 3 L/min (inclusive). In some embodiments, the rates of separation described in this paragraph can be achieved while also achieving the degrees of separation mentioned above.

A variety of applications can, in certain cases, incorporate certain of the separators and methods described herein. In some embodiments, the separator or method is or is part of a chemical synthesis system. In some embodiments, the separator or method is or is part of a system for the separation of multiphasic mixtures (e.g., biphasic mixtures, triphasic mixtures, or higher-order multiphasic mixtures). In some embodiments, the separator and/or method is or is part of a liquid-liquid extraction (e.g., separation of alcohols from organic solvents). In some embodiments, the separator and/or method is or is part of a liquid-gas extraction. In some embodiments, the system and/or method is part of a liquid-liquid-gas extraction. In some embodiments, the system and/or method is part of a liquid-liquid-liquid extraction.

Certain of the embodiments described herein can provide one or more benefits. Certain of the fluidic systems described herein are capable of achieving more effective separation, more effective purification, more effective isolation, more effective recovery, usage of lower volumes of solvents/fluids, ease of use, ease of maintaining cleanliness, ease of scale-up, and/or ease of use on a benchtop.

In some embodiments, separation is controlled by regulating a pressure of the fluidic channel. In some embodiments, pressure may need regulated by the addition of a gas. In some embodiments pressure may be regulated with a variety of external means or pressure regulating valves. Exemplary pressure regulating valves may be electronically controlled, and may or may not enable feedback control. In some embodiments, pressure regulating valves may also be controlled mechanically, or using differential pressure controllers.

In some embodiments, the separators and/or methods described herein can be part of an automated system. Suitable control schemes (e.g., using a controller to control flow rates of various components) can be implemented in any of a number of ways. In some embodiments, the controller comprises one or more processors. The processor may be part of, according to certain embodiments, a computer implemented control system. The computer implemented control system can be used to operate various components of the fluidic system. In general, any calculation methods, steps, simulations, algorithms, systems, and system elements described herein may be implemented and/or controlled using one or more computer implemented control system(s).

The computer implemented control system can be part of or coupled in operative association with one or more pumps and/or other system components that might be automated, and, in some embodiments, is configured and/or programmed to control and adjust operational parameters, as well as analyze and calculate values. In some embodiments, the computer implemented control system(s) can send and receive reference signals to set and/or control operating parameters (e.g., pump speeds) of system apparatus. In other embodiments, the computer implemented system(s) can be separate from and/or remotely located with respect to the other system components and may be configured to receive data from one or more systems of the embodiments via indirect and/or portable means, such as via portable electronic data storage devices, such as magnetic disks, or via communication over a computer network, such as the Internet or a local intranet.

The computer implemented control system(s) may include several known components and circuitry, including a processor, a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

The computer implemented control system(s) may include a processor, for example, a commercially available processor such as one of the series x86; Celeron, Pentium, and Core processors, available from Intel; similar devices from AMD and Cyrix; similar devices from Apple Computer; the 680X0 series microprocessors available from Motorola; and the PowerPC microprocessor from IBM. Many other processors are available, and the computer system is not limited to a particular processor.

A processor typically executes a program called an operating system (of which Windows, UNIX, Linux, DOS, VMS, an MacOS) are examples, which controls the execution of other computer programs and provides scheduling, debugging, input/output control, accounting, compilation, storage assignment, data management and memory management, communication control and related services. The processor and operating system can together define a computer platform for which application programs in high-level programming languages are written. The computer implemented control system is not limited to a particular computer platform.

The computer implemented control system(s) may include a memory system, which typically includes a computer readable and writeable non-volatile recording medium, of which a magnetic disk, optical disk, a flash memory, and tape are examples. Such a recording medium stores signals, typically in binary form (i.e., a form interpreted as a sequence of ones and zeros). Such signals may define a software program, e.g., an application program, to be executed by the microprocessor, or information to be processed by the application program.

The memory system of the computer implemented control system(s) also may include an integrated circuit memory element, which typically is a volatile, random access memory such as a dynamic random access memory (DRAM) or static memory (SRAM). Typically, in operation, the processor causes programs and data to be read from the non-volatile recording medium into the integrated circuit memory element, which typically allows for faster access to the program instructions and data by the processor than does the non-volatile recording medium.

The processor can manipulate the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer implemented control system(s) that implements the methods, steps, systems control and system elements control described above is not limited thereto. The computer implemented control system(s) is not limited to a particular memory system.

At least part of such a memory system described above may be used to store one or more data structures (e.g., look-up tables) or equations such as calibration curve equations. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented control system(s) and components thereof may be programmable using any of a variety of one or more suitable computer programming languages. Such languages may include procedural programming languages, for example, LabView, C, Pascal, Fortran and BASIC, object-oriented languages, for example, C++, Java and Eiffel and other languages, such as a scripting language or even assembly language.

U.S. Provisional Patent Application No. 63/136,072, filed Jan. 11, 2021, and entitled “Fluidic Separators and Associated Methods” is incorporated herein by reference in its entirety for all purposes.

The following example is intended to illustrate certain embodiments of the present invention, but does not exemplify the full scope of the invention.

### EXAMPLE

This example describes the separation of a combined flow, comprising three fluid phases, that was presented to an exemplary separator. In this example, the combined flow was a mixture of water, toluene, and nitrogen gas. The water, toluene, and nitrogen gas phase-separated into: a gas phase that principally comprised nitrogen, an aqueous phase that principally comprised water, and an organic phase that principally comprised toluene. The combined flow of the gas phase, the aqueous phase, and the organic phase was presented to an exemplary separator comprising a hydrophilic porous membrane that acted as the first porous medium portion and hydrophobic porous membrane that acted as the second porous medium portion, where porous membranes were used in either a horizontal or a vertical orientation. The porous membranes were arranged in a manner similar to that shown in FIG. 1A. A flow rate of 50 mL/min of the aqueous phase and the organic phase was used. Porous membranes were pre-wetted. Various pressure differentials were used, and pressures were maintained using an external, commercially available Zaiput SEP-10 pressure controller. In each experiment, the separation was run for between 30 and 60 seconds, and a sample from each product stream was visually inspected to determine quality of separation. In addition, any fluid phase observed to flow through an outlet of the fluidic channel of the separator, rather than reaching a product stream, was collected and noted.

In the first experiment, the exemplary separator had a horizontal orientation and the combined flow had a pressure of 24 psi. A pressure differential across the porous membranes was 9 psi, meaning that the pressure of the product streams was 15 psi. Fluid from the aqueous product stream had a minimal layer of the organic phase, but had become emulsified. Liquid, principally aqueous, was also observed to emerge from the outlet of the fluidic channel.

In the second experiment, the exemplary separator had a horizontal orientation and the combined flow had a pressure of 13.5 psi. The pressure differential across the porous membranes was 4.5 psi. Again, fluid from the aqueous product stream had a minimal layer of the organic phase and had become emulsified. Liquid, principally aqueous, was again observed to emerge from the outlet of the fluidic channel.

In the third experiment, the exemplary separator had a vertical orientation and the combined flow had a pressure of 13.5 psi. The pressure differential across the porous membranes was 4.5 psi. This time, fluid from the aqueous product stream was very clean, with little indication of organic liquid. Fluid from the organic product stream was also very clean, with little indication of aqueous liquid. A small amount of liquid, principally organic, was observed to emerge from the outlet of the fluidic channel.

In the fourth experiment, the exemplary separator had a vertical orientation and the combined flow had a pressure of 15 psi. The pressure differential across the porous membranes was 5 psi. Again, fluid from the aqueous product stream was very clean, with little indication of organic liquid. Fluid from the organic product stream was also very clean, with little indication of aqueous liquid. A small amount of liquid, principally organic, was observed to emerge from the outlet of the fluidic channel.

These experiments demonstrate that separators can be used to separate combined flows comprising a first fluid phase and a second fluid phase. In some cases, separation quality varied with the orientation of the separators with respect to gravity, and with the pressure differential created in the system by the addition of the nitrogen gas.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt %” is an abbreviation of weight percentage. As used herein, “at %” is an abbreviation of atomic percentage.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A separator, comprising:
a fluidic channel comprising an inlet;
a first porous medium portion defining at least a portion of a wall of the fluidic channel, the first porous medium portion between the fluidic channel and a first auxiliary outlet; and
a second porous medium portion defining at least a portion of a wall of the fluidic channel, the second porous medium portion between the fluidic channel and a second auxiliary outlet.

2. The separator of claim 1, wherein the fluidic channel further comprises an outlet.

3. The separator of claim 1, wherein at least a portion of the first porous medium portion faces the second porous medium portion.

4. The separator of claim 1, wherein the first porous medium portion is hydrophilic and the second porous medium portion is hydrophobic.

5. The separator of claim 1, wherein the first porous medium portion is or is part of a porous membrane.

6. The separator of claim 5, wherein the second porous medium portion is or is part of a porous membrane.

7. A method, comprising:
presenting a combined flow comprising a first fluid phase and a second fluid phase to a separator comprising a first porous medium portion and a second porous medium portion, wherein:
the first porous medium portion has a higher affinity for the first fluid phase than for the second fluid phase, such that the first fluid phase is preferentially transported through the first porous medium portion relative to the second fluid phase, and
the second porous medium portion has a higher affinity for the second fluid phase than for the first fluid phase, such that the second fluid phase is preferentially transported through the second porous medium portion relative to the first fluid phase.

8. The method of claim 7, wherein the combined flow further comprises a third fluid phase.

9. The method of claim 7, wherein at least a portion of the first porous medium portion faces the second porous medium portion.

10. The method of claim 7, wherein the first fluid phase is a liquid phase, and the second fluid phase is a liquid phase.

11. The method of claim 7, wherein the first porous medium portion and the second porous medium portion are both hydrophilic, with the first porous medium portion being more hydrophilic than the second porous medium portion.

12. The method of claim 7, wherein the first porous medium portion and the second porous medium portion are both hydrophobic, with the first porous medium portion being more hydrophobic than the second porous medium portion.

13. The method of claim 7, wherein the first porous medium portion is hydrophilic and the second porous medium portion is hydrophobic.

14. The method of claim 13, wherein the first fluid phase is an aqueous liquid phase, and the second fluid phase is a non-aqueous liquid phase.

15. The method of claim 8, wherein the third fluid phase is a gas phase.

16. The method of claim 7, wherein the first porous medium portion defines at least a portion of a first side of a fluidic channel, and the second porous medium portion defines at least a portion of a second side of the fluidic channel facing the first side of the fluidic channel.

17. The method of claim 7, wherein the first porous medium portion is or is part of a porous membrane.

18. The method of claim 17, wherein the second porous medium portion is or is part of a porous membrane.

19. The method of claim 7, further comprising transporting a portion of the combined flow out of the separator and recycling at least a portion of the combined flow that is transported out of the separator back into the separator.

20. The method of claim 7, wherein the volumetric flux of the first fluid phase through the first porous medium portion is at least 1.5 times greater than the volumetric flux of the second fluid phase through the first porous medium portion.

21. The method of claim 20, wherein the volumetric flux of the second fluid phase through the second porous medium portion is at least 1.5 times greater than the volumetric flux of the first fluid phase through the second porous medium portion.
